(19) United States
(12) Patent Application Publication
(10) Pub. No.: US 2009/0295038 A1
(43) Pub. Date: Dec. 3, 2009

(54) Vinylidene fluoride resin monofilament and process for producing the same

(76) Inventors: Satoshi Hashimoto, Ibaraki-Ken (JP); Masaru Satou, Ibaraki-Ken (JP); Masayuki Hino, Ibaraki-Ken (JP); Toshiya Mizuno, Ibaraki-Ken (JP)

Correspondence Address: WENDEROTH, LIND & PONACK, L.L.P., 1030 15th Street, N.W.,, Suite 400 East, Washington, DC, 20005-1503, US

(21) Appl. No.: 12/461,496

(22) Filed: Aug. 13, 2009

Related U.S. Application Data
(62) Division of application No. 10/573,567, filed on Mar. 27, 2006.

(30) Foreign Application Priority Data
Sep. 30, 2003 (JP) 342237/2003(PAT.)

(51) Int. Cl. B29C 71/02

(52) U.S. Cl. 264/345

(57) ABSTRACT

A monofilament obtained by smelt-spinning and stretching of a vinylidene fluoride resin is subjected to a high-temperature relaxation treatment for an extremely short period of 0.05-0.5 sec. within a high-temperature heating oil bath at a temperature of 140-175° C., thereby producing a vinylidene fluoride resin monofilament, which comprises a vinylidene fluoride resin having an inherent viscosity of at least 1.40 dl/g, and has a knot strength (JIS L1013) of at least 600 MPa and excellent anti-twist property represented by a twist index of at least 0.90 when measured after the monofilament being subjected to application for 1 minute of a tensile load equal to approximately 50% of a maximum tensile load (JIS K7113), removal of the load, and standing for 3 hours.

### TECHNICAL FIELD

The present invention relates to a vinylidene fluoride resin monofilament (monofilament of vinylidene fluoride resin) which has a high strength, is flexible and is less liable to twist and is therefore particularly suitable for use as a fishing line, and a process for production thereof.

### BACKGROUND ART

Vinylidene fluoride resin monofilament is excellent in various properties, such as tenacity, impact resistance, tensile force-transmitting property (sensitivity or fish signal detectability) and weatherability, and moreover has a high specific gravity (=1.79) leading to easiness of sinking in water, a refractive index (=ca. 1.42) close to the refractive index (=1.33) of water leading to difficulty for noticeability by seeing and almost no hygroscopicity allowing the preservation of these properties for a long period of time. These properties are regarded as most suitable properties for fishing lines including a line in a narrower sense and a leader, particularly for a leader. For the use as a leader, the greatest attention is paid to a tensile strength at a knot i.e., a knot strength.

In order to enhance the knot strength of a vinylidene fluoride resin monofilament, it is effective to use a resin of a higher molecular weight as a starting material and use a larger stretching ratio at the time of producing the monofilament to provide a higher degree of orientation. A vinylidene fluoride resin, however, has a high crystallinity and a high elastic modulus by its nature resulting in a rigid monofilament, and the hardness is further enhanced at such a higher molecular weight and a higher orientation to result in severe twisting, which gives rise to a difficulty in handling. For this reason, there has not been actually obtained a vinylidene fluoride resin monofilament sufficiently satisfying high knot strength and low twistability in combination. As for attributes relating to the twistability, there have been made studies regarding improvement or readiness of removal of simple twisting or kink, such as that caused when a monofilament is pulled out of a spooled filament, but no studies have been made regarding twisting or kink caused in continuation of the use, i.e., twisting or kink caused after catching fishes, even if straight at the time of initial use after being pulled out of the spool, or non-natural twisting occurring with the continuation of use in water even without catching fishes. Accordingly, a true study is being desired for the prevention of “twisting” inclusive of those occurring with such continual use.

As prior art directed to improvement in properties of vinylidene fluoride resin monofilament, there have been proposed, e.g., (1) a vinylidene fluoride resin monofilament having a lower orientation selectively at the surface layer by a heat treatment under tension at a temperature exceeding the melting point after two steps of stretching (Patent document 1 shown below); (2) a process for producing high-strength polyvinylidene fluoride monofilament, comprising stretching at such a stretching ratio as to provide an average refringence (Δn) of at least 25×10⁻³ after the stretching, and then effecting a high-temperature heat treatment for a short period of 0.02-0.2 second in an inert gas at 500-1000° C. while causing a stretching at 1.0-1.2 times (Patent document 2 shown below); (3) a method of providing a monofilament with less liability of twisting or with readiness of removing the twisting by suppressing the overall stretching ratio including the one at the relaxation step to a relatively low value of 5.2-5.6 times to change the elastic modulus of elongation (Patent document 3 shown below); (4) a process for producing a monofilament having excellent linearity together with a high strength (Patent document 4 shown below); (5) a production process for providing a sufficient knot strength together with improved curlability by subjecting a stretched PVDF monofilament to a relaxation heat treatment in a gaseous atmosphere at a temperature of at least 220° C. and below 300 at a relaxation ratio of at least 4% and below 10% for a passing time of at most 5 sec. (Patent document 5 shown below), (6) a method of adding a large amount of polyester-based plasticizer; and (7) a method of using a copolymer. However, it is yet difficult to regard these proposals as satisfactory.

More specifically, the production processes (1) and (2) aim at a higher knot strength or an improved abrasion resistance, and the production processes (3) and (4) aim at a less liability of twisting or kink and an improved linearity, whereas a high knot strength cannot be expected due to an insufficient stretching by such a low stretching ratio or a single step-stretching alone. The production process (5) is accompanied with a problem that a noticeable lowering of strength is caused if excessive relaxation heat-treatment is applied. Further, the method (6) of adding a large amount of plasticizer is accompanied with problems that the strength is noticeably lowered and the added plasticizer is liable to bleed out to provide a filament surface with a white powdery appearance. The method (7) of simply using a copolymer provides a simply soft filament but fails to provide a monofilament having a high knot strength in combination therewith.

Patent document 1: JP-B 3-50001

Patent document 2: JP-A 7-54211

Patent document 3: JP-A 10-298825

Patent document 4: JP-A 2000-192327

Patent document 5: JP-A 2001-200425 (corresponding to US-B 6677416).

### DISCLOSURE OF INVENTION

Accordingly, a principal object of the present invention is to provide a vinylidene fluoride resin monofilament having mechanical strengths represented by a high knot strength and excellent anti-twist property in combination, and a process for production thereof.

According to studies of the present inventors, it has been discovered that even a highly stretched monofilament of vinylidene fluoride resin of a high polymerization degree as represented by a high inherent viscosity can be improved in anti-twist property while retaining a high knot strength by subjecting it to an extremely short period of relaxation heat treatment with a high-temperature medium of a high heat-conductivity.

The vinylidene fluoride resin monofilament of the present invention is based on the above knowledge and is characterized by comprising a vinylidene fluoride resin having an inherent viscosity of at least 1.40 dl/g, and having a knot strength (JIS L1013) of at least 600 MPa and a twist index of at least 0.90 when measured after the monofilament being subjected to application for 1 minute of a tensile load equal to approximately 50% of a maximum tensile load (JIS K7113), removal of the load, and standing for 3 hours.

Further, the process for producing a vinylidene fluoride resin monofilament of the present invention is characterized by comprising: subjecting a vinylidene fluoride resin monofilament after melt-spinning and stretching to a high-temperature relaxation treatment for an extremely short period of 0.05-0.5 sec. within a high-temperature heating oil bath at a temperature of 140-175° C.

The reason why the extremely short period of relaxation heat-treatment of a stretched vinylidene fluoride resin monofilament within a high-temperature oil bath can provide a remarkably improved anti-twist property while retaining a high knot strength, has not been fully clarified as yet, but it is presumed that, because of the extremely short treatment, the orientation of amorphous portion of the vinylidene fluoride resin constituting the monofilament can be effectively relaxed without causing substantial crystallization.

### BEST MODE FOR PRACTICING THE INVENTION

Hereinbelow, suitable embodiments of practice of the vinylidene fluoride resin monofilament and the process for production thereof according to the present invention, will be described.

### <Vinylidene Fluoride Resin>

As a vinylidene fluoride resin used in the present invention, homopolymer of vinylidene fluoride resin may preferably be used. Further, without being restricted thereto, examples of other vinylidene fluoride resins may include copolymers of vinylidene fluoride monomer and one or more species of monomers copolymerizable therewith, and mixtures of such copolymers with homopolymer of vinylidene fluoride resin.

Examples of the monomer copolymerizable with vinylidene fluoride may include: tetrafluoroethylene, hexafluoropropylene, trifluoroethylene, trifluorochloroethylene and vinyl fluoride, and these can be used singly or in mixture of two or more species. The content of vinylidene fluoride in these vinylidene fluoride resins may preferably be at least 50 mol %, more preferably at least 60 mol %, particularly preferably at least 80 mol %.

In the present invention, a vinylidene fluoride resin having a high molecular weight represented by an inherent viscosity (referring to a logarithmic viscosity at 30° C. of a solution of 4 g of resin in 1 liter of N,N-dimethylformamide; hereinafter sometimes denoted by “ηᵢₙₕ”) of at least 1.40 dl/g, is used. Such a high-molecular weight vinylidene fluoride resin is particularly effectively used because it can easily provide a monofilament having a high knot strength through an appropriate high orientation treatment while having a liability of developing a high twistability, but an excellent anti-twist property can be imparted while retaining the high knot strength according to the present invention. The upper limit of the inherent viscosity should desirably be within a range capable of retaining adaptability to melt-spinning and stretching that are ordinarily be adopted for providing high-strength monofilament.

The vinylidene fluoride resin used in the present invention may be used in the form a composition which may include additives such as various organic pigments, polyester-based plasticizers, phthalate ester-based plasticize nucleating agents as represented by flavantron, or resins having good mutual solubility with vinylidene fluoride resin, such as poly(meth)acrylate esters, polyesters and methyl acrylate-isobutylene copolymer, added thereto within an extent not adversely affecting the property of the vinylidene fluoride resin. The content of the vinylidene fluoride resin in such a composition may desirably be at least 60 wt. %, further preferably at least 70 wt. %.

Further, as the above-mentioned plasticizer, it is preferred to use a polyester which comprises a recurring unit formed by a dialcohol having 2-4 carbon atoms and a dicarboxylic acid having 4-6 carbon atoms, has a terminal group of a monovalent acid group or an alcohol residue group having 1-3 carbon atoms and has a molecular weight of 1500-4000. Such a plasticizer may preferably be used in a proportion of 0.5-10 wt. parts per 100 wt. parts of the vinylidene fluoride resin.

### <Vinylidene Fluoride Resin Monofilament>

The monofilament of vinylidene fluoride resin (hereinafter representatively designated by “PVDF”) according to the present invention is composed of a single layer or plural layers of which at least the surface layer (sheath material) comprises PVDF. That is, the monofilament may be composed of a single layer of PVDF or composed of plural layers including an inner layer (core material) which can be composed of a single layer or plural layers comprising a thermoplastic resin other than PVDF, such as, e.g., polyamide or polyolefin, and a surfacemost layer (sheath material) comprising PVDF. Preferably, it is suitable that the overall structure is composed of PVDF in either case of the monofilament being composed of a single layer or plural layers.

According to a preferred embodiment, the PVDF monofilament of the present invention has a core-sheath laminar structure comprising a core and a sheath each comprising PVDF, particularly a laminar structure comprising a core of PVDF having a higher ηᵢₙₕ and a sheath of PVDF having a lower ηᵢₙₕ. As mentioned before, PVDF of a high ηᵢₙₕ is generally liable to provide a difficulty in melt-spinning and high-ratio stretching, but the above-mentioned core-sheath structure allows the melt-spinning and high-ratio stretching even by using such a core of high ηᵢₙₕ PVDF, thus allowing the formation of a PVDF monofilament having a high effective ηᵢₙₕ. Herein, the effective ηᵢₙₕ is obtained as a weighted average based on the weights of ηᵢₙₕ of the core PVDF and ηᵢₙₕ of the sheath but can be conveniently determined by way of measuring a logarithmic viscosity of a solution at 30° C. of a monofilament having such a core-sheath structure at a concentration of 4 g/liter in N, N-dimethylformamide.

The PVDF monofilament of the present invention is characterized by a knot strength (JIS L1013) of at least 600 MPa, preferably 650 MPa or higher, and a twist index of at least 0.90, preferably 0.92 or higher, when measured after the monofilament being subjected to application for 1 minute of a tensile load equal to ca. 50% of the maximum load (JIS K7113), removal of the load and standing for 3 hours.

Herein, the twist index is defined as a practical property representing an anti-twist property of a high-strength PVDF monofilament and is measured in the following manner. More specifically, a monofilament sample is wound about a spool having a winding barrel diameter of 44 mm and then left standing together with the spool for 7 days in an oven warmed at 40° C. Thereafter, the monofilament is restored to a room temperature atmosphere (23° C., 65% RH), pulled in a length of ca. 1 m out of the spool and elongated in a vertical line to be nipped between upper and lower chucks of a tensile tester (“STROGRAPH RII”, made by K.K. Toyo Seiki Seisakusho) so as to provide a vertical test length of 500 mm. Then, the monofilament sample is pulled at a crosshead speed of 500 mm/min. and held for 1 min. at a load corresponding to ca. 50% (shown in Table 1 below for some filament diameters) of the maximum tensile load (JIS K7113) of the monofilament sample, followed by cutting of the monofilament at a point just above the lower chuck. Thereafter, the vertical length of the monofilament hanging down by its own weight from the upper chuck to the lower end of the monofilament at points of time of 1 minute, 1 hour and 3 hours, respectively, thereafter, whereby the respective lengths are divided by the initial monofilament length of 500 mm to obtain twist indexes. The measurement is repeated at a measurement number n=3, and average twist indexes are obtained. Twist indexes closer to 1 and less decreasing with time represent a monofilament having less liability of twisting, and this has been also confirmed by actual fishing tests. Accordingly a twist index of at least 0.90 after the release of load is a feature defining the PVDF monofilament of the present invention.

TABLE 1
A table of loads for filament twisting test

| | Filament diameter (mm) | | | | | | |
|---|---|---|---|---|---|---|---|
| | 0.06 | 0.13 | 0.16 | 0.22 | 0.26 | 0.29 | 0.40 |
| Applying load | 1.0 | 4.9 | 7.8 | 14.7 | 24.5 | 29.5 | 49.0 |
| (N) | | | | | | | |

The diameter of the PVDF monofilament of the present invention is not particularly restricted but may preferably be in a range of 52 μm (corresponding to No. 0.1 of fishing line)−1.81 mm (No. 120), particularly preferably 100-1000 μm.

Next, the process for producing a PVDF monofilament according to the present invention will be described with reference to a preferred embodiment thereof. First, a mixture composition of the above-mentioned PVDF, plasticizer, etc., is melt-extruded into a form of pellets. The pellets are melt-spun at a prescribed resin temperature of, e.g., 240-320° C. through a melt extruder having prescribed diameter of, e.g., 20-50 mm. Then, the melt-spun monofilament is cooled in a cooling bath (e.g., a water bath at a temperature of 30-80° C.) to obtain a non-stretched PVDF monofilament.

Now, in the case of obtaining a PVDF monofilament of a single layer, a single species of vinylidene fluoride resin can be used, and in the case of obtaining a structure of plural layers, it is possible to use vinylidene fluoride resins of different or similar compositions, viscosities, additives, etc., another resin, a compositions comprising either of these, or mixtures of these resins or compositions, as starting materials. As mentioned before, in the case of forming a PVDF of plural layers, it is possible to use a vinylidene fluoride resin or a composition thereof as the sheath material, and a vinylidene fluoride resin, another resin, a composition comprising either of these or a mixture of such resins or compositions, as the core material.

Then, the thus-obtained non-stretched PVDF monofilament is stretched, e.g., at ca. 5-6 times in a heat medium bath (e.g., a glycerin bath at a temperature of 150-170° C.) (1st. stretching). Then, the monofilament is further stretched, e.g., at ca. 1-1.3 times in a heat medium bath (e.g., a glycerin bath at a temperature of 160-170° C.) (2nd. stretching). Thus, the stretching process is composed of the 1st. and 2nd. stretching steps.

The final stretching ratio through the stretching process is not particularly restricted but may preferably be at least 5 times, more preferably at least 5.9 times, further preferably 6 times or higher. This provides an enhanced orientation of molecular chains of the vinylidene fluoride resin suitable for obtaining the PVDF monofilament of the present invention having a knot strength of at least 600 MPa and a twist index of at least 0.90 after 3 hours of standing.

Then, the PVDF monofilament after the stretching is subjected to a high-temperature relaxation heat treatment in a heating oil bath at a temperature of 140-170° C., preferably 145-170° C., for an extremely short period of 0.05-0.5 sec, preferably 0.1-0.41 sec. The relaxation (percentage) (lengthwise shrinkage) in this instance is preferably in a range of 1-14%, particularly 3-12%.

If the heating oil temperature is below 140° C. or the heat treatment time is below 0.05 sec, the improvement in anti-twist property through a desired relaxation percentage is scarce. On the other hand, if the heating oil temperature is above 175° C. or the heat treatment time exceeds 0.5 sec., it becomes difficult to retain mechanical strengths represented by a high knot strength of at least 600 MPa.

The heat medium constituting the heating oil bath may conveniently be glycerin, but it is also possible to use an arbitrary medium, such as silicone oil or polyethylene glycol, that is chemically stable and does not exhibit an excessively large vapor pressure at the heating temperature of 140-175° C.

The PVDF monofilament after the heat treatment is wound up about a spool and is subjected to storage, circulation and use.

In addition to the above-mentioned knot strength and twist index, the thus-obtained PVDF monofilament of the present invention may have a knot elongation of preferably 16-35%, particularly preferably 18-30%, and a Young's modulus of preferably 1500-3500 MPa, particularly preferably 2000-3000 MPa.

### EXAMPLES

Hereinbelow, the present invention will be described more specifically based on Examples and Comparative Examples. Incidentally, physical properties other than “twist index” (measuring method therefor having been described before) described in the present specification are based on values measured according to the following methods.

### [Testing Methods]

### (1) Melting Point

Referring to a heat absorption peak temperature measured by using “DSC7” (made by Perkin-Elmer Corporation) at a temperature-raising rate of 10° C./min in an N₂ atmosphere according to the DSC (differential scanning colorimeter) described at JIS-K7121.

(2) Inherent Viscosity (ηᵢₙₕ)

A sample was dissolved in N,N-dimethyl-formamide at a concentration of 0.4 g/dl, and a viscosity of the solution at 30° C. was measured by an Ubbelohde viscometer. A relative viscosity ηᵣ was obtained as a ratio of the solution viscosity to a viscosity of the solvent at the same temperature, and a natural logarithm ln ηᵣ of the solution viscosity was multiplied by a reciprocal of the concentration (1/0.4 (g/dl), to obtain an inherent viscosity ηᵢₙₕ.

### (3) Knot Strength

A knot was formed at a middle point of a sample of 300 mm in test length, and the sample was subjected to a tensile test by using a tensile tester (“STROGRAPH RII”) at a tensile speed of 300 mm/min. in a room of 23° C. and 65% RH. The measurement was repeated 5 times (n=5) to obtain a knot strength.

### (4) Young's Modulus

Measured by using a tensile tester (“TENSILON UTM-III-100”, made by K.K. Toyo Seiki Seisakusho) at a test length of 100 mm and a tensile speed of 10 mm/min. in a room of 23° C. and 65% RH. The measurement was performed at a pitch of 0.1 mm from an initial elongation of 0% to a terminal elongation of 3%. The measurement was repeated 5 times (n=5). The date was processed by using a data processing software (available from Orientek K.K.) to calculate a Young's modulus.

### <Starting Resins>

The following 3 grades of PVDF having different inherent viscosities (each made by Kureha Kagaku Kogyo K.K.)

Resin A: ηᵢₙₕ=1.7 dl/g, melting point=172° C. (trade name:“KF#1700”)
Resin B: ηᵢₙₕ=1.5 dl/g, melting point=173° C. (trade name:“KF#1550”)
Resin C: ηᵢₙₕ=1.3 dl/g, melting point=174° C. (trade name:“KF#1300”)

Each resin (in 100 wt. parts) was mixed with 2-6.5 wt. parts, as desired, of a polyester-based plasticizer (adipic acid-1,2-propylene glycol-based polyester)

### <Monofilament Layer Structure>

### Layer Structure (1)

core: Resin A+polyester plasticizer 4 wt. parts/

sheath: Resin C+polyester plasticizer 2 wt. parts

### Layer Structure (2)

core: Resin B+polyester plasticizer 6.5 wt. Parts/

sheath: Resin C+polyester plasticizer 5 wt. parts

### Layer Structure (3)

A single layer of Resin C+polyester plasticizer 5 wt. parts

### Comparative Example 1

The starting materials for Layer structure (1) were subjected to spinning by using two 35 mm-dia. extruders at an extrusion temperature of 310° C. and a 1.3 mm-dia. composite nozzle at composition ratio (by weight) of core:sheath=8:2 and quenching in water at a cooling temperature of 50° C. The spun product was then stretched at 5.45 times in a glycerin bath at 167° C. and further stretched at 1.15 times in a glycerin bath at 172° C. to provide a total stretching ratio of 6.27 times, followed by a relaxation heat-treatment in a water bath at 87° C. for a residence time of 10.5 sec. to cause a relaxation of 7%, thereby obtaining a monofilament of 0.29 mm in diameter.

The outline of the above-described monofilament production and the knot strength and twist indexes (including a value measured after immediately after unwinding from the spool and in a state of hanging from the upper chuck by its own weight in addition to the values at 1 min., 1 hour and 3 hours after the release of the load) are inclusively summarized in Table 2 appearing hereafter together with those of the products obtained in Examples and Comparative Examples described below.

The resultant monofilament exhibited a sufficient knot strength of 720 MPa, whereas the twist index was low (0.81 at 3 hours after the release of load) and then tended to be lowered with time. The monofilament was used in an actual fishing test. As a result, the monofilament exhibited a serious trace of winding when unwound from the line spool. The monofilament was used for fishing after straightening it, by pulling with hands, whereas the monofilament caused a twisting or unnatural curving with time even without catching a fish, and after catching a fish, the monofilament kinked up and was no more usable thereafter.

### Comparative Example 2

The starting materials for Layer structure (2) using Resin B having a lower inherent viscosity (ηᵢₙₕ=1.5) as the core material instead of Resin A were subjected to spinning by using a core-side extruder of 35 mm diameter, and a sheath-side extruder of 25 mm diameter at an extrusion temperature of 280° C. and also a 1.5 mm-dia. composite nozzle and quenching in water at a cooling temperature of 55° C. The spun product was then stretched at 5.8 times in a glycerin bath at 167° C. and further stretched at 1.06 times (totally 6.17 times) in a glycerin bath at 172° C., followed by a relaxation heat-treatment in a water bath at 87° C. for a residence time of 9.3 sec. to cause a relaxation of 6%, thereby obtaining a monofilament of 0.29 mm in diameter, otherwise in the same manner as in Comparative Example 1.

Because of the use of a resin having a lower inherent viscosity, the thus-obtained monofilament was not sufficiently improved in anti-twist property in spite of the lowering in knot strength, so that it was unsatisfactory as a fishing line.

### Comparative Example 3

The starting material for Layer structure (3) using Resin C having a still lower inherent viscosity (ηᵢₙₕ=1.3) was subjected to spinning by using a single 35 mm-dia. extruder at an extrusion temperature of 290° C. and a 2 mm-dia. single-layer nozzle and quenching in water at a cooling temperature of 50° C. The spun product was then stretched at 5.23 times in a glycerin bath at 168° C. and further stretched at 1.04 times (totally 5.44 times) in a glycerin bath at 172° C., followed by a relaxation heat-treatment in a water bath at 87° C. for a residence time of 8.70 sec. to cause a relaxation of 7%, thereby obtaining a 0.29 mm-dia. single-layer monofilament.

Because of the adoption of lower-ratio stretching conditions, the resultant monofilament exhibited an improved anti-twist property, whereas the knot strength was low so that it was unsatisfactory as a fishing line.

### Comparative Example 4

A 0.29 mm-dia. monofilament was prepared in the same manner as in Comparative Example 1 except for performing a relaxation heat treatment causing a relaxation of 7% by using a dry heat-relaxation vessel at 240° C. for a residence time of 2.24 sec.

Because of the relaxation heat treatment for a relatively short time at a high temperature though under a dry heat condition giving a poor heat conductivity, the thus-obtained monofilament exhibited a relatively high twist index immediately after the twisting test but the twist index was lowered with time (0.87 at 3 hours after the release of load), so that it was still unsatisfactory as a fishing line.

### Example 1

A 0.29 mm-dia. monofilament was prepared in the same manner as in Comparative Example 1 except for performing a high-temperature relaxation heat treatment for an extremely short period by using glycerin used for stretching in Comparative Example 1 as the heat medium for the relaxation heat treatment at a glycerin temperature of 158° C. for a residence time of 0.1 sec. to cause a relaxation of 6%.

The thus-obtained monofilament exhibited a high knot strength and also a high twist index. The monofilament was used in an actual fishing test. As a result, the monofilament exhibited little trace of winding after unwinding from the spool and could be straightened easily by pulling with hands. The monofilament was also free from twisting with time during its use and caused only little kink or twist even after catching a fish so that it was possible to catch several fishes (such as sea breams). Incidentally, the monofilament exhibited a Young's modulus of 2380 MPa which was lower by ca. 400 MPa than that of a monofilament obtained after relaxation in warm water (Comparative Example 1), so that some textural change was presumed to have occurred in the monofilament.

### Example 2

A 0.26 mm-dia. monofilament was prepared in the same manner as in Example 1 (that is, as in Comparative Example 1) except for performing the high-temperature heat relaxation treatment for a short period by using the same glycerin bath as in Example 1 at a glycerin temperature of 165° C. for a residence time of 0.26 sec. to effect a relaxation of 8%.

The thus-obtained monofilament exhibited a twist index of almost 1 over the entire period of the twisting test and was found to be a very well-behaving monofilament.

### Examples 3-14

Monofilaments which respectively exhibited a high strength and a high twist index and were well-behaving, were obtained in the same manner as Example 1 except that the layer structures and the conditions for the glycerin heat-relaxation treatment were changed as shown in Table 2.

### Example 15

The starting materials for Layer structure (2) were subjected to spinning by using a core-side extruder of 35 mm diameter, a sheath side diameter of 25 mm diameter at an extrusion temperature of 280° C. and also a 1.0 mm-dia. composite nozzle to provide a composite ratio (by weight) of 8:2 and quenching in water at a cooling temperature of 35° C. The spun product was stretched at 5.72 times in a glycerin bath at 168° C. and further stretched at 1.075 times (totally 6.15 times) in a glycerin bath at 170° C., followed by a high-temperature short-period relaxation heat treatment at a glycerin temperature of 170° C. for a residence time of 0.05 sec. to cause a relaxation of 5%, thereby obtaining a 0.14 mm-dia. monofilament.

The thus-obtained monofilament exhibited a high twist index and good behavior regardless of a high knot strength, and was therefore found to be suitable as a fishing line.

### Example 16

The starting materials for Layer structure (1) were subjected to spinning by using a core-side extruder of 35 mm diameter, a sheath side diameter of 25 mm diameter at an extrusion temperature of 320° C. and also a 1.0 mm-dia. composite nozzle to provide a composite ratio (by weight) of 8:2 and quenching in water at a cooling temperature of 45° C.

The spun product was stretched at 5.50 times in a glycerin bath at 167° C. and further stretched at 1.145 times (totally 6.3 times) in a glycerin bath at 172° C., followed by a high-temperature short-period relaxation heat treatment at a glycerin temperature of 160° C. for a residence time of 0.13 sec. to cause a relaxation of 7%, thereby obtaining a 0.22 mm-dia. monofilament.

The thus-obtained monofilament exhibited a high twist index and good behavior regardless of a high knot strength, and was therefore found to be suitable as a fishing line.

### Example 17

A 0.26 mm-dia. monofilament was prepared in the same manner as in Example 16 except for using a 1.2 mm-dia. composite nozzle for the spinning and performing the high-temperature short-period relaxation heat treatment at a glycerin temperature of 165° C. for a residence time of 0.14 sec. to cause a relaxation of 7%.

The thus-obtained monofilament exhibited a high twist index and good behavior regardless of a high knot strength, and was therefore found to be suitable as a fishing line.

### Example 18

A 0.40 mm-dia. monofilament was prepared in the same manner as in Example 16 except for using a 1.2 mm-dia. composite nozzle for the spinning, followed by quenching in water at a cooling temperature of 55° C., stretching at 5.55 times in a glycerin bath at 167° C., further stretching at 1.14 times (totally 6.33 times) in a glycerin bath at 172° C., and then performing the high-temperature short-period relaxation heat treatment at a glycerin temperature of 165° C. for a residence time of 0.41 sec. to cause a relaxation of 6%.

The thus-obtained monofilament exhibited a high twist index and good behavior regardless of a high knot strength, and was therefore found to be suitable as a fishing line.

### Example 19

A 0.40 mm-dia. monofilament was prepared in the same manner as in Example 18 except for performing the high-temperature short-period relaxation heat treatment at a glycerin temperature of 170° C. for a residence time of 0.25 sec. to cause a relaxation of 7%.

The thus-obtained monofilament exhibited a high twist index and good behavior regardless of a high knot strength, and was therefore found to be suitable as a fishing line.

### Comparative Examples 5-8

0.29 mm-dia. monofilaments were prepared in the same manner as in Example 1 except for changing the conditions for the glycerin relaxation heat treatment as shown in Table 2.

As shown in Table 2, the monofilaments were problematic, e.g., because of insufficient twist indexes, or melting-down or slackening of monofilaments in the relaxation bath.

The outline of the monofilament production conditions and the knot strength and twist index of the resultant monofilaments in the above-described Examples and Comparative Examples are inclusively summarized in Table 2 below.

TABLE 2
Summary of Test conditions and Results

| | | | Filament | Relaxation | Residence | | Knot | Twist index | | | |
|---|---|---|---|---|---|---|---|---|---|---|---|
| | Layer | Heat | diameter | temp. | time | Relaxation | strength | After unwinding | Time after release of load | | |
| Example | structure | medium | [mm] | [° C.] | [sec] | [%] | [MPa] | from the spool | 1 min. | 1 hr. | 3 hrs. |
| Comp. 1 | (1) | warm water | 0.29 | 87 | 10.53 | 7 | 720 | 0.50 | 0.86 | 0.82 | 0.81 |
| Comp. 2 | (2) | warm water | 0.29 | 87 | 9.30 | 6 | 667 | 0.43 | 0.90 | 0.88 | 0.87 |
| Comp. 3 | (3) | warm water | 0.29 | 87 | 8.70 | 7 | 568 | 0.55 | 0.98 | 0.97 | 0.97 |
| Comp. 4 | (1) | dry heat | 0.29 | 240 | 2.24 | 7 | 724 | 0.55 | 0.93 | 0.89 | 0.87 |
| 1 | (1) | glycerin | 0.29 | 158 | 0.1 | 6 | 731 | 0.71 | 0.94 | 0.93 | 0.92 |
| 2 | (1) | glycerin | 0.29 | 165 | 0.26 | 8 | 729 | 0.77 | 1.01 | 1.00 | 0.99 |
| Comp. 5 | (1) | glycerin | 0.29 | 127 | 0.06 | 6 | 714 | 0.67 | 0.92 | 0.89 | 0.87 |
| 3 | (1) | glycerin | 0.29 | 145 | 0.06 | 6 | 715 | 0.71 | 0.94 | 0.93 | 0.92 |
| 4 | (1) | glycerin | 0.29 | 157 | 0.06 | 6 | 721 | 0.74 | 0.95 | 0.94 | 0.94 |
| 5 | (1) | glycerin | 0.29 | 170 | 0.1 | 6 | 731 | 0.57 | 0.96 | 0.91 | 0.92 |
| 6 | (1) | glycerin | 0.29 | 175 | 0.1 | 6 | 712 | 0.57 | 0.99 | 0.95 | 0.95 |
| Comp. 6 | (1) | glycerin | 0.29 | 180 | — | — | Melted down | | | | |
| Comp. 7 | (1) | glycerin | 0.29 | 165 | 0.1 | 0 | 700 | 0.60 | 0.94 | 0.90 | 0.88 |
| 7 | (1) | glycerin | 0.29 | 165 | 0.1 | 1 | 710 | 0.57 | 0.95 | 0.91 | 0.91 |
| 8 | (1) | glycerin | 0.29 | 165 | 0.1 | 2 | 719 | 0.59 | 0.95 | 0.92 | 0.91 |
| 9 | (1) | glycerin | 0.29 | 165 | 0.1 | 4 | 747 | 0.63 | 0.96 | 0.92 | 0.92 |
| 10 | (1) | glycerin | 0.29 | 165 | 0.1 | 6 | 738 | 0.60 | 0.98 | 0.96 | 0.95 |
| 11 | (1) | glycerin | 0.29 | 165 | 0.1 | 8 | 732 | 0.64 | 0.99 | 0.99 | 0.97 |
| 12 | (1) | glycerin | 0.29 | 165 | 0.1 | 10 | 721 | 0.66 | 1.01 | 0.98 | 0.98 |
| 13 | (1) | glycerin | 0.29 | 165 | 0.1 | 12 | 677 | 0.68 | 1.02 | 1.00 | 1.00 |
| 14 | (1) | glycerin | 0.29 | 165 | 0.1 | 14 | 679 | 0.72 | 1.03 | 1.01 | 1.01 |
| Comp. 8 | (1) | glycerin | 0.29 | 165 | 0.1 | 16 | Slackening occurred | | | | |
| 15 | (2) | glycerin | 0.14 | 170 | 0.05 | 5 | 759 | 0.95 | 0.98 | 0.96 | 0.95 |
| 16 | (1) | glycerin | 0.22 | 160 | 0.13 | 7 | 698 | 0.75 | 1.00 | 0.99 | 0.99 |
| 17 | (1) | glycerin | 0.26 | 165 | 0.14 | 7 | 676 | 0.69 | 0.94 | 0.96 | 0.96 |
| 18 | (1) | glycerin | 0.40 | 165 | 0.41 | 6 | 638 | 0.70 | 1.02 | 1.00 | 0.99 |
| 19 | (1) | glycerin | 0.40 | 170 | 0.25 | 7 | 651 | 0.62 | 0.99 | 0.98 | 0.98 |

### INDUSTRIAL APPLICABILITY

As described above, according to the present invention, there is provided a vinylidene fluoride resin monofilament, particularly suitable as a fishing line, which comprises a high-molecular weight vinylidene fluoride resin having an inherent viscosity of at least 1.40 dl/g, retains a high knot strength of at least 600 MPa and is remarkably improved in anti-twist property that has been a drawback of a conventional high-knot strength monofilament of vinylidene fluoride resin. The monofilament is produced through a simple process of subjecting a vinylidene fluoride resin monofilament after melt-spinning and stretching to a high-temperature relaxation treatment for an extremely short period of 0.05-0.5 sec. within a high-temperature heating oil bath at a temperature of 140-175° C.

1-5. (canceled)

6. A process for producing a vinylidene fluoride resin monofilament, comprising: subjecting a vinylidene fluoride resin monofilament having an inherent viscosity of at least 1.40 dl/g after melt-spinning and stretching to a high-temperature relaxation treatment for an extremely short period of 0.05-0.5 sec. within a high-temperature heating oil bath at a temperature of 140-175° C.

7. The process according to claim 6, wherein the vinylidene fluoride resin monofilament has been stretched at a ratio of at least 5 times prior to the relaxation heat treatment.

8. The process according to claim 6, wherein a relaxation of 1-14% is given in the relaxation heat treatment.

9. The process according to claim 6, wherein the heating oil bath comprises glycerin, silicone oil or polyethylene glycol.

10-11. (canceled)

12. The process according to claim 6, wherein the vinylidene fluoride resin monofilament comprises a vinylidene fluoride resin having an inherent viscosity of at least 1.40 dl/g, and has a knot strength (JIS L1013) of at least 650 MPa and a twist index of at least 0.90 when measured after the monofilament being subjected to application for 1 minute of a tensile load equal to approximately 50% of a maximum tensile load (JIS K7113), removal of the load, and standing for 3 hours.

13. The process according to claim 6, wherein the vinylidene fluoride resin monofilament has a twist index of at least 0.92.

14. The process according to claim 6, wherein the vinylidene fluoride resin monofilament has a knot elongation of 16-35% and a Young's modulus of 1500-3500 MPa.

15. The process according to claim 6, wherein the vinylidene fluoride resin monofilament has a diameter of 52 mm-1.81 mm.

16. The process according to claim 6, wherein the vinylidene fluoride resin monofilament is used in a fishing line.

17. The process according to claim 16, wherein the fishing line is wound about a spool.

18. The process according to claim 6, wherein the vinylidene fluoride resin monofilament has a core-sheath laminar structure comprising a core having a higher inherent viscosity and a sheath having a lower inherent viscosity.
